(19) United States
(12) Patent Application Publication
(10) Pub. No.: US 2006/0010273 A1
(43) Pub. Date: Jan. 12, 2006

(54) CAM-less command context implementation

(76) Inventor: Sridharan Sakthivelu, DuPont, WA (US)

Correspondence Address: INTEL CORPORATION, P.O. BOX 5326, SANTA CLARA, CA, 95056-5326, US

(21) Appl. No.: 10/877,117

(22) Filed: Jun. 25, 2004

(51) Int. Cl. G06F 9/00

(52) U.S. Cl. 710/112

(57) ABSTRACT

In one embodiment, a method is provided. The method of this embodiment provides in response to a command from an initiator device to a target device, generating a command context associated with the command, assigning a rule-based tag to the command, storing the command context in a command context queue, and forwarding a request having the command and the rule-based tag to a network device of the initiator device.

### FIELD

Embodiments of this invention relate to a CAM (Content Addressable Memory)-less command context implementation.

### BACKGROUND

iSCSI (Internet Small Computer Systems Interface) is a standard for linking systems to I/O (input/output) devices, such as storage devices, in which SCSI (Small Computer Systems Interface) commands may be encapsulated in TCP (Transport Control Protocol/Internet Protocol) packets on an IP (Internet Protocol) network. The iSCSI standard is set forth in RFC (Request For Comments) 3347, entitled “Small Computer Systems Interface protocol over the Internet (iSCSI) Requirements and Design Considerations”, July 2002, available from the Internet Engineering Task Force (IETF). The SCSI standard is set forth in “Information technology—Small Computer System Interface-3—Part 411: SCSI-3 Architecture Model (SCSI-3 SAM) Information technology—Small Computer System Interface-3—Part 411: SCSI-3 Architecture Model (SCSI-3 SAM)”, available from ANSI (American National Standards Institute), New York, N.Y.

In the SCSI and iSCSI protocols, there are two types of devices: initiator devices and target devices. An initiator device may request that one or more operations, such as a read or a write, be performed by the target device. The request may be associated with a command context. A “command context” refers to information about the request, such as where the request came from (e.g., a word processing application), what the request is (e.g., a read operation), and how to process a response to the request (e.g., write the data of the response to a particular address). The request may be associated with a unique, arbitrary identifier called a tag. A tag may enable a response to be correlated to a request, and, therefore, a command context. In one example of prior art, a CAM (content addressable memory) may be used to determine a command context. In a CAM implementation, a CAM may store a pointer to a command context associated with a request by creating an entry in the CAM that includes the tag (along with other information) and the command context pointer. Upon completion of the one or more operations of the request by the target device, the target device may send a response to the initiator device, where the response includes the tag. The initiator device may obtain the command context by using the CAM to correlate the tag with a tag entry, and by using the corresponding pointer to the command context to obtain the command context.

Some disadvantages of using a CAM to store command contexts are that CAM implementations may occupy valuable silicon space, may require complex and expensive validation processes, and may not be scalable due to the limited size of a CAM.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network according to one embodiment.

FIG. 2 illustrates a system according to one embodiment.

FIG. 3 illustrates a method according to one embodiment.

FIG. 4 illustrates another method according to one embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Embodiments of the present invention may be provided, for example, as a computer program product which may include one or more machine-accessible media having machine-executable instructions that, when executed by one or more machines such as a computer, network of computers, or other electronic devices, may result in the one or more machines carrying out operations in accordance with embodiments of the present invention. A machine-accessible medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable media suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

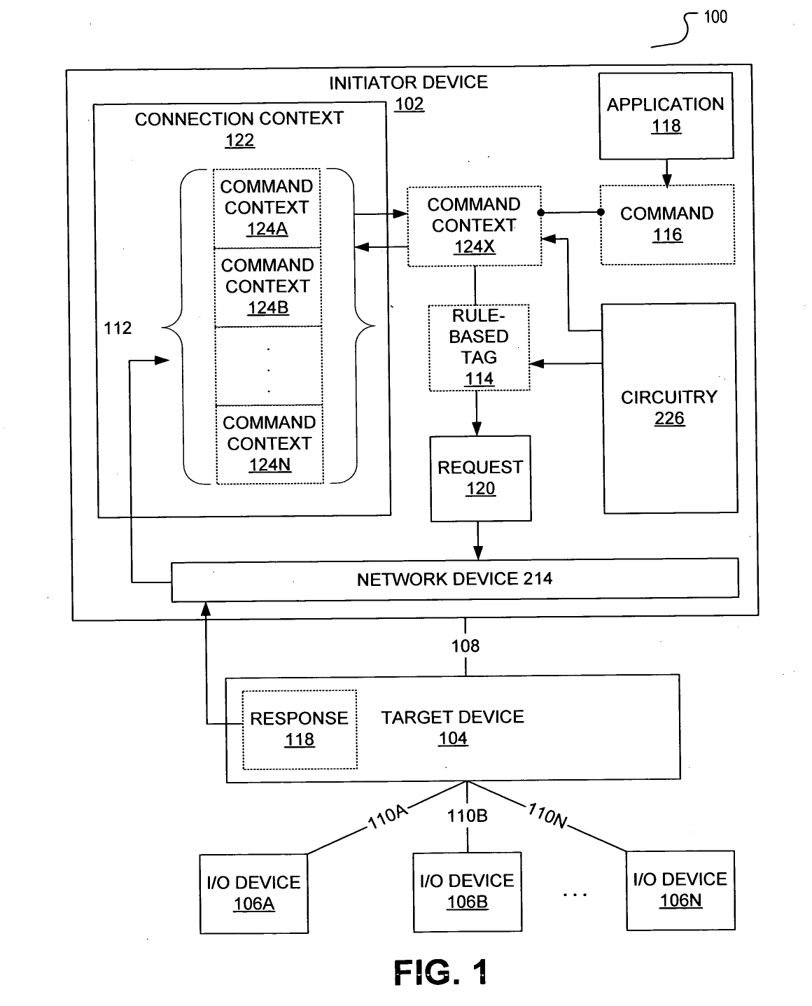

FIG. 1 illustrates a network 100 in one embodiment of the invention. Network 100 may comprise at least one initiator device 102 (only one shown), at least one target device 104 (only one shown), and at least one I/O device 106A, 106B, . . . , 106N. As used herein, “initiator device” refers to a device that may request that one or more operations be completed by a target device, and a “target device” refers to a device that may perform the one or more operations and respond to the request.

For example, initiator device 102 may request data from target device 104, and target device 104 may access requested data from I/O device 106A, 106B, . . . , 106N. In one embodiment, an initiator device 102 may comprise, for example, a client, and a target device 104 may comprise, for example, a server. Furthermore, an I/O device 106A, 106B, . . . , 106N may comprise, for example, a storage device. A storage device may include, for example, a hard drive, tape drive, CD (Compact Disc) and DVD (Digital Versatile Disc) drive, printer, and scanner.

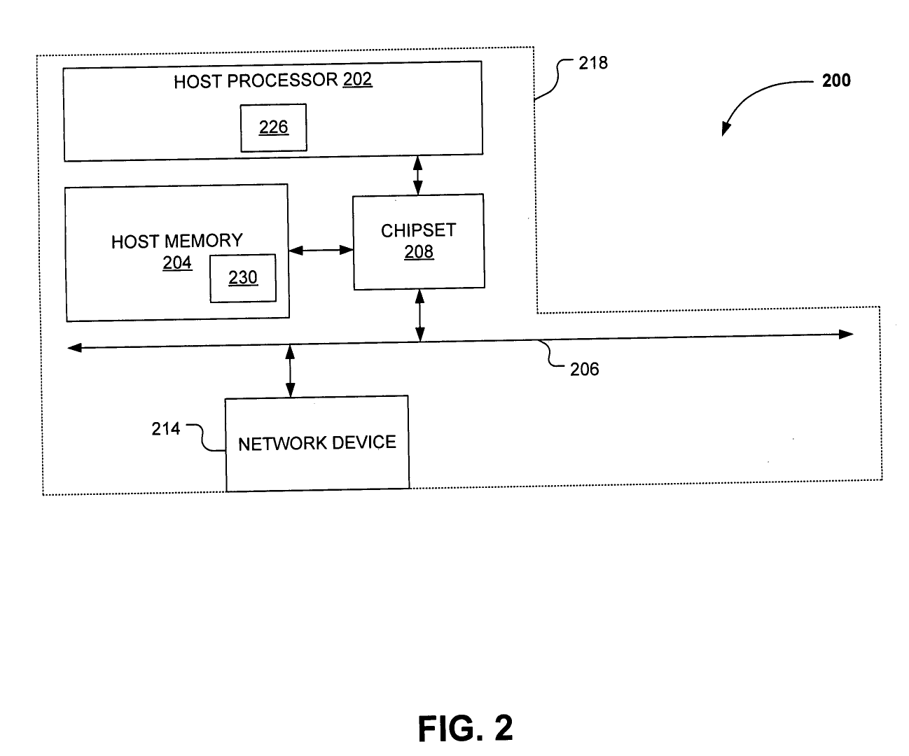

In one embodiment, initiator device 102 and target device 104 may each comprise a system, such as system 200 illustrated in FIG. 2. System 200 may comprise host processor 202, chipset 208, bus 206, circuitry 226, and host memory 204. System 200 may comprise more than one, and other types of processors, memories, buses, and chipsets; however, the former are illustrated and described for simplicity of discussion. Host processor 202, chipset 208, bus 206, circuitry 226, and host memory 204 may be comprised in a single circuit board, such as, for example, a system motherboard 218.

Host processor 202 may comprise, for example, an Intel® Pentium® microprocessor that is commercially available from the Assignee of the subject application. Of course, alternatively, host processor 202 may comprise another type of microprocessor, such as, for example, a microprocessor that is manufactured and/or commercially available from a source other than the Assignee of the subject application, without departing from this embodiment.

Chipset 208 may comprise a host bridge/hub system that may couple host processor 202, and host memory 204 to each other and to bus 206. Alternatively, host processor 202, host memory 204, and/or circuitry 226 may be coupled directly to bus 206, rather than via chipset 208. Chipset 208 may also include an I/O bridge/hub system (not shown) that may couple a host bridge/bus system of chipset 208 to bus 206. Chipset 208 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”), the PCI-X Specification Rev. 1.0a, Jul. 24, 2000, (hereinafter referred to as a “PCI-X bus”), or the PCI-E Specification Rev. PCI-E (hereinafter referred to as a “PCI-E bus”), as specified in “The PCI Express Base Specification of the PCI Special Interest Group”, Revision 1.0a, both available from the PCI Special Interest Group, Portland, Oreg., U.S.A. Bus 106 may comprise other types and configurations of bus systems.

System 200 may additionally comprise circuitry 226. Circuitry 226 may comprise one or more circuits to perform one or more operations described herein as being performed by circuitry 226. Circuitry 226 may be hardwired to perform the one or more operations, and/or may execute machine-executable instructions to perform these operations. For example, circuitry 226 may be comprised in host processor 202 and may execute machine-executable instructions 230 to perform one or more operations describe herein as being performed by circuitry 226. As another example, circuitry 226 may comprise memory (not shown) that may store machine-executable instructions, such as machine-executable instructions 230, that may be executed by circuitry 226 to perform these operations. Circuitry 226 may comprise, for example, one or more digital circuits, one or more analog circuits, one or more state machines, programmable circuitry, and/or one or more ASIC's (Application-Specific Integrated Circuits).

Instead of being comprised in host processor 202, some or all of circuitry 226 may be comprised in other structures, systems, and/or devices that may be, for example, comprised in motherboard 218, and/or communicatively coupled to bus 206, and may exchange data and/or commands with one or more other components in system 200. As used herein, devices that are “communicatively coupled” means that the devices may be capable of communicating with each other via wirelined (e.g., copper wires), or wireless (e.g., radio frequency) means. Many possibilities exist; however, not all possibilities are illustrated or described.

System 200 may comprise one or more memories to store machine-executable instructions 230 capable of being executed, and/or data capable of being accessed, operated upon, and/or manipulated by circuitry, such as circuitry 226. For example, these one or more memories may include host memory 204. One or more memories 204 may, for example, comprise read only, mass storage, random access computer-accessible memory, and/or one or more other types of machine-accessible memories. The execution of machine-executable instructions 230 and/or the accessing, operation upon, and/or manipulation of this data by circuitry 226 may result in, for example, system 200 and/or circuitry 226 carrying out some or all of the operations described herein.

System 200 may additionally comprise a network device 214. A “network device” refers to a device that may enable a first system to communicate with a second system via a network. Network device 214 may comprise a NIC (network interface card), a TOE (Transport Offload Engine), and/or an HBA (Host Bus Adapter), for example. In one embodiment, system 200, such as initiator device 102 or target device 104, may each comprise a NIC or, alternatively, a TOE. Also, system 200, such as target device 104, may additionally comprise an HBA to communicate with I/O device 106A, 106B, . . . , 106N.

Initiator device 102 may communicate with target device 104 via communication medium 108, and target device 104 and at least one I/O device 106A, 106B, . . . , 106N may each communicate via communication medium 110A, 110B, . . . , 110N. As used herein, a “communication medium” means a physical entity through which electromagnetic radiation may be transmitted and/or received. Communication medium 108 and 110A, 110B, . . . , 110N may comprise, for example, one or more optical and/or electrical cables, although many alternatives are possible. For example, communication medium 108 and 110A, 110B, . . . , 110N may comprise air and/or vacuum, through which nodes may wirelessly transmit and/or receive sets of one or more signals. Initiator device 102 and target device 104 may transmit and receive sets of one or more signals via communication medium 108 that may encode one or more packets. As used herein, a “packet” means a sequence of one or more symbols and/or values that may be encoded by one or more signals transmitted from at least one sender to at least one receiver.

In one embodiment, initiator device 102 and target device 104 may form a LAN (Local Area Network), and target device 104 and at least one I/O device 106A, 106B, . . . , 106N may form a SAN (Storage Area Network). A “LAN” refers to a network of computers, such as workstations, personal computers, and servers, for example. A “SAN” refers to a network of storage devices connected to each other and to one or more servers that act as an access point to the storages devices. In one embodiment, LAN may comprise an Ethernet LAN. The Ethernet is a LAN that complies with the IEEE (Institute of Electrical and Electronics Engineers) 802.3 standard. The current specification for the IEEE 802.3 standard is set forth in Information “Technology—Telecommunication & Information Exchange Between Systems—LAN/MAN—Specific Requirements—Part 3: Carrier Sense Multiple Access with Collision Detection (CSMA/CD) Access Method and Physical Layer Specifications”, 2002, published by IEEE. Network 100 may comprise one or more intermediate devices (not shown), such as expanders, bridges, routers, and switches, and associated links to couple the intermediate devices to the target device 104 and I/O devices 106A, 106B, . . . , 106N. Of course, embodiments of the invention are not limited to the described and/or illustrated networks.

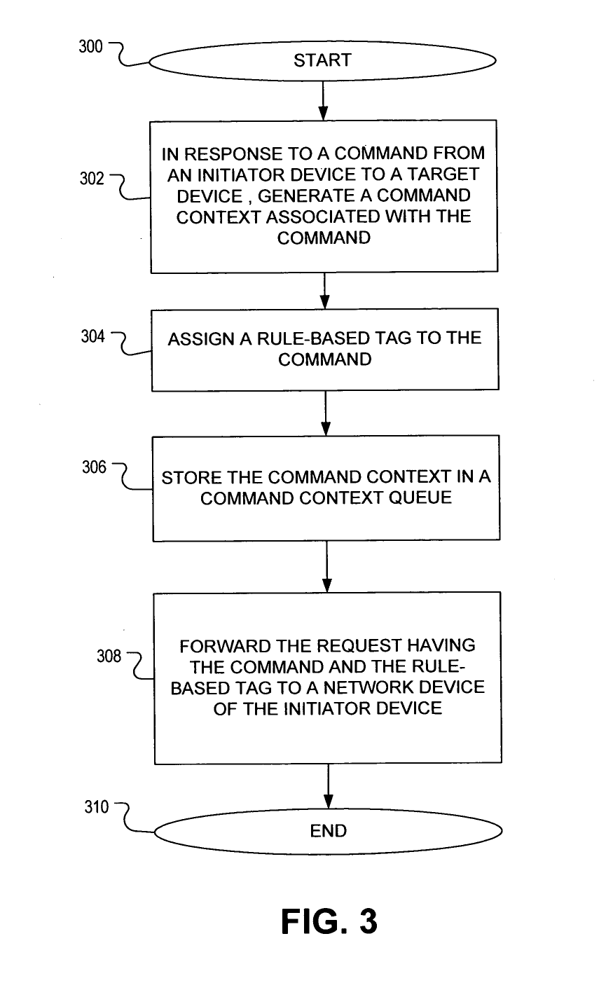

FIG. 3 illustrates a method for assigning a rule-based tag to a request in one embodiment, with reference to FIG. 1 and FIG. 2. In this embodiment, initiator device 102 and target device 104 may each comply with the iSCSI standard for communication. In this embodiment, circuitry 226 may refer to an iSCSI driver on initiator device 102 or on target device 104. iSCSI driver may comprise machine-executable instructions residing in memory 204, and executable by host processor 202.

The method begins at block 300 and continues to block 302 where, in response to a command 116 from initiator device 102 to target device 104, circuitry 226 may generate a command context associated with the command 116.

The command 116 may be to the target device 104 to perform one or more operations, and may be initiated by, for example, application 118. The command 116 may be associated with a connection context. As used herein, a “context” refers to a physical or a virtual connection for transmitting and receiving communications between a first device and a second device. In one embodiment, a connection context may comprise a global connection context. A “global connection context” refers to a connection context used by each first device-second device pair.

In another embodiment, a connection context may comprise a local connection context. A “local connection context” refers to a connection context used by a single first device-second device pair. For example, communications between initiator device 102 and target device 104 may be associated with one connection context, and communications between initiator device 102 and another device (not shown) may be associated with different connection context. As another example, communications between initiator device 102 and I/O device 106A may be associated with one connection context, and communications between initiator device 102 and I/O device 106B may be associated with different connection context.

At block 304, circuitry 226 may assign a rule-based tag 114 to the command 116. In one embodiment, each operation may comprise a SCSI command, and the completion of an operation by target device 104 may comprise carrying out the SCSI command.

A “rule-based tag”, as used herein, refers to an identifier that may be generated in accordance with a rule. In one embodiment, rule-based tag 114 may be, for each connection context, a whole number within a range (e.g., 0 to 9), and may be generated sequentially for each command 116. In another embodiment, rule-based tag 114 may be, for all connection contexts, a whole number within a range (e.g., 0 to 9), and may be generated sequentially for each command 116. Rather than being generated sequentially, rule-based tag 114 may be generated according to a formula, such as X+2, where X may be the previously generated rule-based tag 114. Other possibilities exist. For example, rule-based tag 114 may be a fixed number within each connection context, or within all connection contexts for each command 116. Additionally, or alternatively, rule-based tag may be related to locations in a command context queue 112. In one embodiment, a rule-based tag 114 may comprise an ITT (initiator task tag) generated by initiator device 102, or a TTT (Transfer Target Tag) generated by target device 104.

At block 306, the command context 124X may be stored in a command context queue 112. A command context queue 112 may store a number of command contexts 124A, 124B, . . . , 124N, each command context 124A, 124B, . . . , 124N retrievable based on a rule-based tag 114. In one embodiment, there may be one global command queue that stores all command contexts 124A, 124B, . . . , 124N across all connection contexts. In another embodiment, there may be multiple command context queues, where each command context queue may store command contexts 124A, 124B, . . . , 124N associated with a given connection context, such as for example, connection context 122.

The command context 124X may be stored in a command context queue 112 in accordance with a command context correlation scheme. A “command context correlation scheme” refers to a protocol for storing and accessing command contexts. For example, a command context correlation scheme may indicate how many command context queues may be used, as well as what location within a selected command context queue a given command context may be stored.

In one embodiment, a command context queue, such as command context queue 112, which may store command contexts across all connection contexts, may be used. Furthermore, a unique rule-based tag 114 may be assigned to each command 116, and may correspond to a unique location in the command context queue 112. Alternatively, a single rule-based tag 114 may be assigned to each command 116, and a function over the rule-based tag 114 may correspond to a unique location in the command context queue 112. For example, the function may comprise using the rule-based tag 114 in conjunction with the command queue depth to generate a value that corresponds to a location in command context queue 112 at which command context. 124X may be stored.

Other command context correlation schemes may be used, including, but not limited to:

Where a plurality of command context queues are used, each to store a number of command contexts 124A, 124B, . . . , 124N for a given connection context, a unique rule-based tag 114 may be assigned to each command 116 associated with the same connection context, and may correspond to a unique location in a corresponding command context queue 112.

Where a plurality of command context queues are used, each to store a number of command contexts 124A, 124B, . . . , 124N for a given connection context, a single rule-based tag 114 may be assigned to each command 116 associated with the same connection context, and a function over the single rule-based tag 114 may correspond to a unique location in a corresponding command context queue 112.

At block 308, circuitry 226 may forward a request 116 having the rule-based tag 114 to a network device 214 of initiator device 102. In one embodiment, the request 116 may comprise a SCSI CDB, which may be encapsulated in an iSCSI protocol data unit (PDU). The request 116 may be forwarded to target device 104 over a connection 108, such as a TCP/IP connection.

In one embodiment, target device 104 may perform the one or more operations of the command 116, and generate a response 118 to the request 120, the response comprising the rule-based tag 114. The response 118 may be transmitted to network device 214 of initiator device 102.

The method ends at block 310.

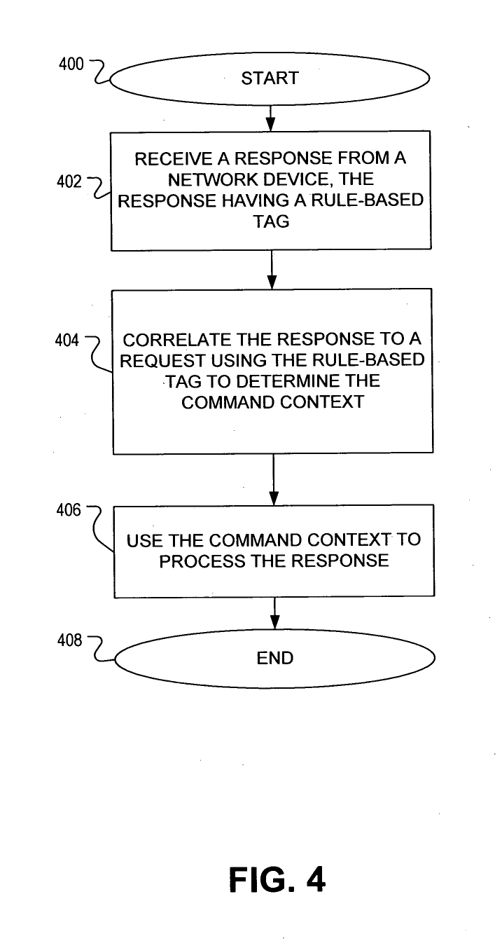

FIG. 4 illustrates a method for obtaining the command context without a CAM in one embodiment. The method begins at block 400 and continues to block 402 where circuitry 226 may receive a response 118 from network device 214, where the response 118 may include a rule-based tag 114. Circuitry 226 in this embodiment may comprise hardware or microcode on initiator device 102. For example, circuitry 226 may be an integrated circuit in a microengine of a TOE. The response 118 may be comprised in a SCSI CDB that may be encapsulated in an iSCSI PDU.

At block 404, circuitry 226 may correlate the response 118 to a request using the rule-based tag 114 to determine the command context. In one embodiment, the rule-based tag 114 may be directly used to generate a value corresponding to a location in the command context queue 112, where the location may comprise the command context 124X of the response 118 and request 116 pair. In another embodiment, a function over the rule-based tag 114 may be used to generate a value corresponding to a location in the command context queue 112, where the location may comprise the command context 124X of the response 118 and request 116 pair.

At block 406, circuitry 226 may use the command context 124X to process the response 118. For example, the request 116 may comprise a command to target device 104 to perform a read operation from one or more I/O devices 106A, 106B, . . . , 106N. When target device 104 performs the read operation, it may send a response 118 back to initiator device 102, where the response 118 may include the data resulting from the read operation. Circuitry 226 may obtain the command context 124X corresponding to the request 116 and response 118 pair, where the command context 124X may comprise information such as a location at which to store the read data, and what application requested the read data. Upon obtaining the command context 124X, circuitry 226 may process the response 118 by writing the data to the location indicated by the command context 124X. Furthermore, circuitry 226 may process the response 118 by sending a completion status to the application indicated by the command context 124X.

The method ends at block 408.

### CONCLUSION

While embodiments describe and illustrate the generation of requests for tasks from an initiator device, and the transmission of these requests to a target device, it should be appreciated that all operations that may be applicable to an initiator device may be equally applicable to a target device.

Therefore, in one embodiment, a method may comprise in response to a command from an initiator device to a target device, generating a command context associated with the command, assigning a rule-based tag to the command, storing the command context in a command context queue, and forwarding a request having the command and the rule-based tag to a network device of the initiator device.

Embodiments of the invention may enable command contexts to be determined without the use of a CAM. By using a rule-based tag limited to values imposed by a rule, a rule-based tag may be correlated to a command context queue location either by using the rule-based tag directly, or by using a function of the rule-based tag, thereby eliminating the need to look-up a command context in a CAM.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
in response to a command from an initiator device to a target device, generating a command context associated with the command;
assigning a rule-based tag to the command;
storing the command context in a command context queue; and
forwarding a request having the command and the rule-based tag to a network device of the initiator device.

2. The method of claim 1, wherein the command is associated with a local connection context.

3. The method of claim 2, wherein the rule-based tag comprises an identifier unique to the local connection context.

4. The method of claim 1, wherein the command is associated with a global connection context.

5. The method of claim 4, wherein the rule-based tag comprises an identifier unique to the global connection context.

6. The method of claim 4, wherein the initiator device and the target device both comply with iSCSI (Internet Small Computer System Interface) protocol.

7. The method of claim 6, wherein the rule-based tag comprises an ITT (initiator task tag).

8. The method of claim 7, wherein the ITT is generated incrementally.

9. The method of claim 1, wherein said storing the command context in a command context queue comprises storing the command context in a command context queue in accordance with a command context correlation scheme.

10. The method of claim 1, additionally comprising:
receiving a response from a network device, the response having the rule-based tag;
correlating the response to the request using the rule-based tag to determine the command context; and
using the command context to process the response.

11. An apparatus comprising:
circuitry capable of:
in response to a command from an initiator device to a target device, generating a command context associated with the command;
assigning a rule-based tag to the command;
storing the command context in a command context queue; and
forwarding a request having the command and the rule-based tag to a network device of the initiator device.

12. The apparatus of claim 11, wherein said storing the command context in a command context queue comprises storing the command context in a command context queue in accordance with a command context correlation scheme.

13. The apparatus of claim 11, additionally comprising:
receiving a response from a network device, the response having the rule-based tag;
correlating the response to the request using the rule-based tag to determine the command context; and
using the command context to process the response.

14. A system comprising:
a TOE (Transport Offload Engine); and
a driver communicatively coupled to the TOE, and capable of:
in response to a command to a target device, generating a command context associated with the command;
assigning a rule-based tag to the command;
storing the command context in a command context queue; and
forwarding a request having the command and the rule-based tag to the TOE.

15. The system of claim 14, wherein the command is associated with a local connection context.

16. The system of claim 14, wherein said driver capable of storing the command context in a command context queue is additionally capable of storing the command context in a command context queue in accordance with a command context correlation scheme.

17. The system of claim 14, additionally comprising a microengine on a TOE, the TOE capable of:
receiving a response from a network device, the response having the rule-based tag;
correlating the response to the request using the rule-based tag to determine the command context; and
using the command context to process the response.

18. An article comprising a machine-readable medium having machine-accessible instructions, the instructions when executed by a machine, result in the following:
in response to a command from an initiator device to a target device, generating a command context associated with the command;
assigning a rule-based tag to the command;
storing the command context in a command context queue; and
forwarding a request having the command and the rule-based tag to a network device of the initiator device.

19. The article of claim 18, wherein said instructions that result in storing the command context in a command context queue additionally comprise instructions that result in storing the command context in a command context queue in accordance with a command context correlation scheme.

20. The article of claim 18, wherein the instructions additionally result in:
receiving a response from a network device, the response having the rule-based tag;
correlating the response to the request using the rule-based tag to determine the command context; and
using the command context to process the response.
